(19) United States
(12) Patent Application Publication
(10) Pub. No.: US 2026/0091310 A1
(43) Pub. Date: Apr. 2, 2026

(54) GAME CONTROLLER

(71) Applicants: NINTENDO CO., LTD., Kyoto (JP); NOMURA Co., Ltd., Tokyo (JP)

(72) Inventors: Kozo KAMIMURA, Kyoto (JP); Norihisa YABE, Kyoto (JP); Akimitsu KISHI, Tokyo (JP); Masao NAGAO, Tokyo (JP)

(21) Appl. No.: 19/313,081

(22) Filed: Aug. 28, 2025

(30) Foreign Application Priority Data
Oct. 1, 2024 (JP) 2024-172630

(51) Int. Cl. A63F 13/24; A63F 13/213

(52) U.S. Cl. CPC A63F 13/24; A63F 13/213

(57) ABSTRACT

This game controller includes a housing, and a directional pad including a pad top configured to receive an input operation and at least partially exposed from an opening provided to the housing, and a cross-shaped plate member provided being covered by the pad top. In the housing, an optical sensor configured to detect movement of the cross-shaped plate member performed by the input operation, a cushion portion configured to inhibit movement of the cross-shaped plate member according to the input operation, and a stopper portion configured to limit movement of the cross-shaped plate member according to the input operation, are provided. In the housing, the cushion portion and the stopper portion are arranged in an order of the cushion portion and then the stopper portion from a center of the cross-shaped plate member toward the optical sensor.

### CROSS REFERENCE TO RELATED APPLICATION

This application claims priority to Japanese Patent Application No. 2024-172630 filed on October 1, 2024, the entire contents of which are incorporated herein by reference.

### FIELD

The present disclosure relates to a structure of a directional pad of a game controller.

### BACKGROUND AND SUMMARY

Conventionally, there has been known a directional pad having a rubber-switch structure.

Regarding the structure of the directional pad as described above, there is room for providing a new structure for a directional pad.

In view of the above circumstances, configuration examples are disclosed below.

### Configuration 1

A configuration 1 is a game controller including: a housing; a directional pad including a pad top configured to receive an input operation and at least partially exposed from an opening provided to the housing, and a cross-shaped plate member provided being covered by the pad top; an optical sensor provided in the housing and configured to detect movement of the cross-shaped plate member performed by the input operation; a cushion portion provided in the housing and configured to inhibit movement of the cross-shaped plate member according to the input operation; and a stopper portion provided in the housing and configured to limit movement of the cross-shaped plate member according to the input operation. In the housing, the cushion portion and the stopper portion are arranged in an order of the cushion portion and then the stopper portion from a center of the cross-shaped plate member toward the optical sensor.

According to the above configuration, a new directional pad structure can be provided.

### Configuration 2

In a configuration 2 based on the above configuration 1, the cross-shaped plate member may have a detection target portion at a position that is on a distal end side in a predetermined direction of the cross-shaped plate member and closer to the optical sensor than the stopper portion, and the optical sensor may be located at a position on an outer side relative to the detection target portion, and may detect the detection target portion in accordance with the input operation.

According to the above configuration, the size of the optical sensor can be reduced.

### Configuration 3

In a configuration 3 based on the above configuration 1 or 2, the game controller may further include a base portion to which a shaft portion of the directional pad, the cushion portion, the stopper portion, and the optical sensor are provided.

### Configuration 4

In a configuration 4 based on the above configuration 3, the shaft portion of the directional pad may include a cross-shaped shaft member provided in the housing, and a first fixation portion fixing both ends of a shaft corresponding to a first direction of a cross shape of the shaft member, to the base portion, and a second fixation portion fixing both ends of a shaft corresponding to a second direction perpendicular to the first direction, to the cross-shaped plate member.

### Configuration 5

In a configuration 5 based on the above configuration 1 or 2, on a direction axis perpendicular to directions of a cross shape of the cross-shaped plate member, a height of the cushion portion may be greater than a height of the stopper portion.

### Configuration 6

In a configuration 6 based on the above configuration 1 or 2, the optical sensor may be a photo sensor, and a detection range of the photo sensor may be smaller than a width of an end in a predetermined direction of the cross-shaped plate member.

According to the above configuration, the size of the optical sensor can be reduced. Owing to the size reduction, erroneous detection can be prevented.

The present disclosure makes it possible to provide a new structure for a directional pad.

### BRIEF DESCRIPTION OF THE DRAWINGS

FIG. 1 schematically shows a non-limiting example of an overall configuration of a controller 1 according to the exemplary embodiment;

FIG. 2 shows a non-limiting example of an operation of the controller 1;

FIG. 3 schematically shows a non-limiting example of an internal configuration of a directional pad portion 11;

FIG. 4 schematically shows a non-limiting example of an internal configuration of the directional pad portion 11;

FIG. 5 illustrates a non-limiting example of a relationship between a detection target portion and a photo sensor;

FIG. 6 illustrates a non-limiting example of a relationship between a detection target portion and a photo sensor;

FIG. 7 illustrates a non-limiting modification example of the exemplary embodiment;

FIG. 8 illustrates a non-limiting modification example of the exemplary embodiment; and

FIG. 9 illustrates a non-limiting modification example of the exemplary embodiment.

### DETAILED DESCRIPTION OF NON-LIMITING EXAMPLE EMBODIMENTS

Hereinafter, an exemplary embodiment will be described. The exemplary embodiment relates to a structure of a game controller (hereinafter, simply referred to as a controller), and specifically, relates to a structure of a directional pad.

### Outer Appearance

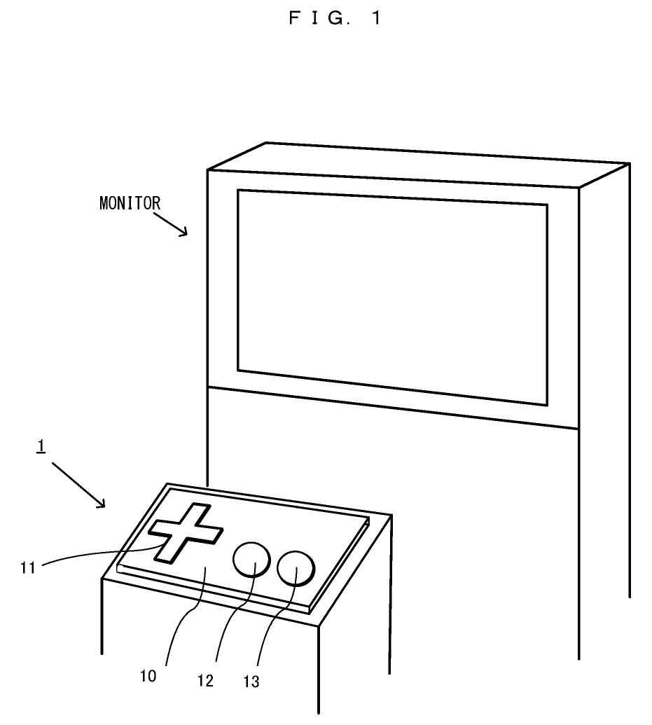

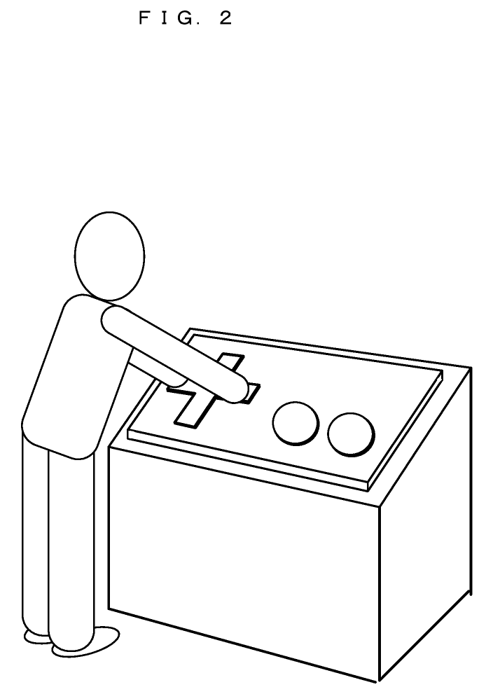

FIG. 1 shows the outer appearance of a controller 1 according to the exemplary embodiment. FIG. 2 shows an example of an operation on the controller 1 according to the exemplary embodiment. In FIG. 1, the controller 1 includes a housing 10, a directional pad portion 11, a first button portion 12, and a second button portion 13. The directional pad portion 11, the first button portion 12, and the second button portion 13 are exposed from openings provided to the housing 10. In the exemplary embodiment, the controller 1 is installed in a fixed state on a predetermined installation base. The controller 1 has such a size that does not allow an operation by a fingertip. To perform an operation, for example, as shown in FIG. 2, a player presses each direction part of the directional pad portion 11 by the palm of the right hand or the left hand, whereby the player can perform a directional instruction operation. Regarding a game using the controller 1, in FIG. 2, one player is playing, but two or more players may play. For example, it is assumed that a first player operates the directional pad portion 11, and a second player (not shown in FIG. 2) operates the first button portion 12 by the left hand and operates the second button portion 13 by the right hand.

### Structure of directional pad portion

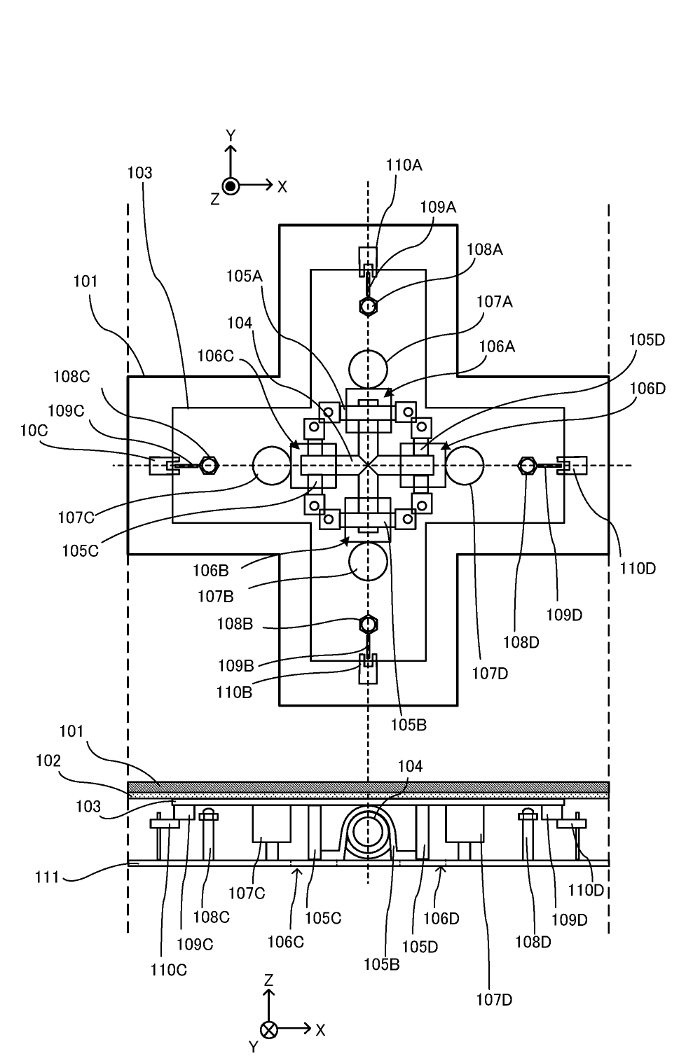

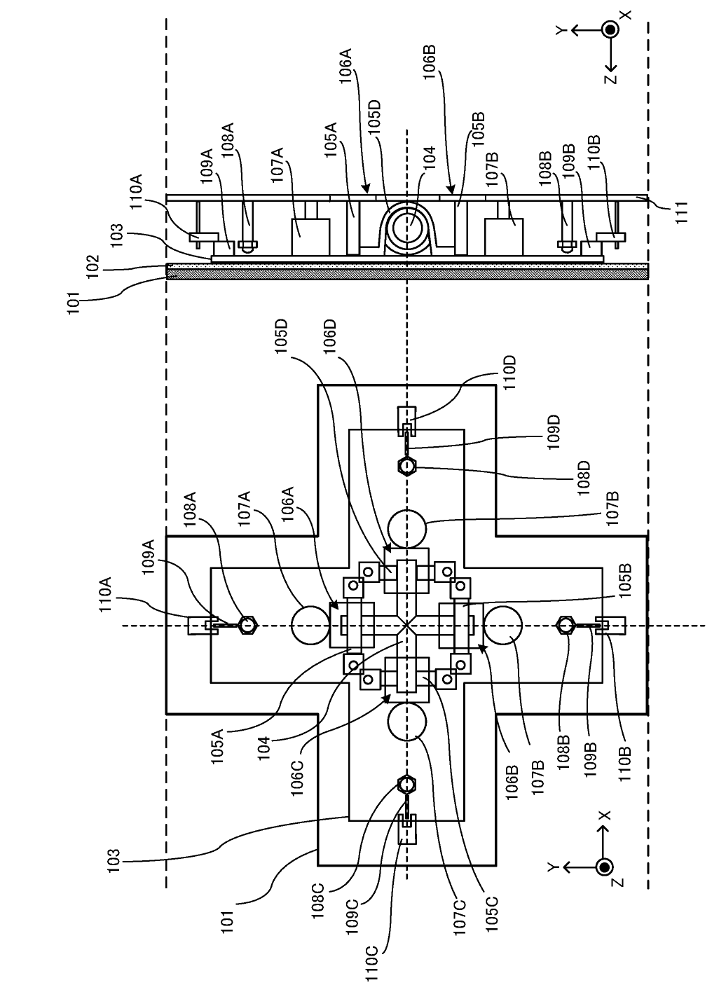

Next, an internal structure of the directional pad portion 11 will be described. FIG. 3 and FIG. 4 schematically illustrate an internal structure of the directional pad portion 11. FIG. 3 is a plan view schematically showing the directional pad portion 11 in a see-through manner from above, and a lower side face view showing the directional pad portion 11 as seen from a side surface on the down direction side. FIG. 4 is a plan view showing the directional pad portion 11 in a see-through manner from above as in FIG. 3, and a right side face view showing the directional pad portion 11 as seen from a side surface on the right direction side. In the following description, the positive direction of Y axis in FIG. 3 and FIG. 4 is defined as an "up direction" of the directional pad portion 11, the negative direction of Y axis is defined as a "down direction" of the directional pad portion 11, the positive direction of X axis is defined as a "right direction" of the directional pad portion 11, and the negative direction of X axis is defined as a "left direction" of the directional pad portion 11. The positive direction of Z axis is defined as a "front direction" of the directional pad portion 11, and the negative direction of Z axis is defined as a "back direction" of the directional pad portion 11.

In FIG. 3 and FIG. 4, the directional pad portion 11 has a directional pad top 101 on the outermost side in the front direction, a first member 102 provided toward the back direction therefrom, and a cross-shaped top plate portion 103 provided further toward the back direction therefrom.

The directional pad top 101 is a member having a cross shape and larger than the cross-shaped top plate portion 103. The material of the directional pad top 101 is, for example, a resin material. The first member 102 is a member serving as a base to which the directional pad top 101 is attached. In a plan view, the outer shape and the size of the first member 102 are substantially the same as those of the directional pad top 101. That is, the first member 102 has a cross shape as with the directional pad top 101. The first member 102 is provided so as to cover the cross-shaped top plate portion 103. The cross-shaped top plate portion 103 is a plate member made of metal, for example, and has the same outer shape as the directional pad top 101 and the first member 102. That is, the cross-shaped top plate portion 103 has a cross shape. The size of the cross-shaped top plate portion 103 is similar, for example.

The directional pad portion 11 has a cross shaft portion 104 having a cross shape, cushion portions 107A to 107D, stopper portions 108A to 108D, detection target portions 109A to 109D, and photo sensors 110A to 110D, on the back direction side relative to the cross-shaped top plate portion 103. On a side further toward the back direction, a second member 111 is provided. The cushion portions 107A to 107D, the stopper portions 108A to 108D, and the photo sensors 110A to 110D are provided to the second member 111. Thus, the second member 111 serves also as a base for these components. On the other hand, the detection target portions 109A to 109D are provided to the cross-shaped top plate portion 103. The size of the second member 111 may have such a size that allows the above components to be placed thereon. The shape of the second member 111 may be a cross shape as with the directional pad top 101, for example, or may be a square shape or a rectangular shape, for example.

### Central Part of Directional Pad Portion

Next, a configuration at a part around the center corresponding to the center axis of the directional pad portion 11 will be described. The cross shaft portion 104 is located with its center at the center of the directional pad portion 11. The cross shaft portion 104 is a member made of metal, for example, and has a cross shape, as is also shown in FIG. 3. A bearing portion (up) 105A is provided at an upper end part of the cross shaft portion 104, and a bearing portion (down) 105B is provided at a lower end part of the cross shaft portion 104. The bearing portion (up) 105A is a member having substantially a U shape, and is fixed to the second member 111 while covering the upper end part of the cross shaft portion 104 from the front direction side toward the back direction side. Similarly, the bearing portion (down) 105B is fixed to the second member 111 while covering the lower end part of the cross shaft portion 104. That is, both ends in the Y-axis direction of the cross shaft portion 104 are fixed to the second member 111 by these bearing portions.

A bearing portion (right) 105D is provided at a right end part of the cross shaft portion 104, and a bearing portion (left) 105C is provided at a left end part of the cross shaft portion 104. The bearing portion (right) 105D is a member having substantially a U shape, and both ends of the bearing portion (right) 105D are fixed to the cross-shaped top plate portion 103 while covering the right end part of the cross shaft portion 104 from the back direction side toward the front direction side, as shown in FIG. 4. Similarly, the bearing portion (left) 105C is fixed to the cross-shaped top plate portion 103 while covering the left end part of the cross shaft portion 104. That is, both ends in the X direction of the cross shaft portion 104 are fixed to the cross-shaped top plate portion 103 by these bearing portions. In other words, the cross shaft portion 104 is placed so as to be held between the cross-shaped top plate portion 103 and the second member 111 with the four bearing portions interposed therebetween.

The second member 111 has rectangular openings 106A to 106D at positions near the right end, the left end, the upper end, and the lower end of the cross shaft portion 104. Specifically, in a plan view, the opening (up) 106A is provided at a position overlapping the upper end of the cross shaft portion 104. The opening (down) 106B is provided at a position overlapping the lower end of the cross shaft portion 104. The opening (left) 106C is provided at a position overlapping the left end of the cross shaft portion 104. The opening (right) 106D is provided at a position overlapping the right end of the cross shaft portion 104.

When a predetermined direction side of the directional pad top 101 is pressed, one end of the cross shaft portion 104 (therefore the cross-shaped top plate portion 103) is tilted toward the second member 111 side due to the pressing. At this time, in a case where one of the upward side and the downward side of the directional pad top 101 is pressed, the upper end part or the lower end part of the cross shaft portion 104 moves through the opening 106 further toward the back direction side relative to the second member 111 without being blocked by the second member 111. On the other hand, in a case where one of the leftward side and the rightward side of the directional pad top 101 is pressed, the leftward or rightward side of the cross shaft portion 104, and the bearing portion (left) 105C or the bearing portion (right) 105D, move through the opening 106 toward the back direction side. This is because the bearing portion (up) 105A and the bearing portion (down) 105B are fixed to the second member 111 but the bearing portion (left) 105C and the bearing portion (right) 105D are fixed to the cross-shaped top plate portion 103.

### Configurations regarding Directions of Directional Pad

Next, configurations regarding up, down, left, and right direction key parts of the directional pad portion 11 will be described. The cushion portions 107A to 107D, the stopper portions 108A to 108D, the detection target portions 109A to 109D, and the photo sensors 110A to 110D are arranged one by one on the upward, downward, leftward, and rightward sides of the directional pad portion 11. Regarding the arrangement, first, on the upward side, the cushion portion (up) 107A, the stopper portion (up) 108A, the detection target portion (up) 109A, and the photo sensor (up) 110A are arranged in this order along a line extending upward from the center of the cross shaft portion 104 (the center of the directional pad portion 11). On the downward side, the cushion portion (down) 107B, the stopper portion (down) 108B, the detection target portion (down) 109B, and the photo sensor (down) 110B are arranged in this order along a line extending downward from the center of the cross shaft portion 104. On the leftward side, the cushion portion (left) 107C, the stopper portion (left) 108C, the detection target portion (left) 109C, and the photo sensor (left) 110C are arranged in this order along a line extending leftward from the center of the cross shaft portion 104. On the rightward side, the cushion portion (right) 107D, the stopper portion (right) 108D, the detection target portion (right) 109D, and the photo sensor (right) 110D are arranged in this order along a line extending rightward from the center of the cross shaft portion 104.

Hereinafter, a configuration regarding the right direction of the directional pad portion 11 (right direction key part) will be described for each component. Configurations regarding the directions other than the right direction are different only in terms of up, down, left, and right directions and are the same in the other matters. Therefore, the detailed description for the other directions are omitted.

### Cushion Portion

The cushion portion (right) 107D is a member for absorbing and mitigating impact when an end of the directional pad top 101 (cross-shaped top plate portion 103) pressed and operated contacts the stopper portion (right). In addition, the cushion portion (right) 107D also serves to provide a reaction force for bringing back the directional pad top 101 into a non-pressed state (hereinafter, referred to as a neutral state). That is, the cushion portion (right) 107D is a member for inhibiting movement of the directional pad top 101 pressed and operated. The cushion portion (right) 107D is an elastic member having a columnar shape and made of an urethane material, for example. As shown in FIG. 3, the cushion portion (right) 107D is provided to the second member 111 at a position toward the center side of the directional pad portion 11 relative to the stopper portion (right) 108D. The cushion portion (right) 107D is provided so as to have such a height (distance in the Z axis) that the end on the front direction side contacts with the cross-shaped top plate portion 103 in the neutral state.

### Stopper Portion

The stopper portion (right) 108D is a member for limiting movement of the cross-shaped top plate portion 103 toward the second member 111 side when a pressing operation (for the right direction) is performed. In other words, the stopper portion (right) 108D is a member for providing a limit so that the cross-shaped top plate portion 103 does not move toward the second member 111 side beyond a certain distance. The stopper portion (right) 108D is a rod-shaped metal member, for example. The stopper portion (right) 108D is provided to the second member 111 at a position between the photo sensor (right) 110D and the cushion portion (right) 107D. The stopper portion 108D has such a height that provides a predetermined gap so that the end on the front direction side of the stopper portion (right) 108D does not contact with the cross-shaped top plate portion 103, in the neutral state. In other words, when the directional pad portion 11 is seen in a side view, the height of the stopper portion (right) 108D is smaller than the height of the cushion portion (right) 107D in the neutral state.

### Detection Target Portion

The detection target portion (right) 109D is a plate-shaped member having such a thickness that the detection target portion (right) 109D can move into a groove of the photo sensor (right) 110D described later. The detection target portion (right) 109D is provided to the cross-shaped top plate portion 103 at a center position of the right end of the cross-shaped top plate portion 103 and extends toward the second member 111 side. In a plan view, the detection target portion (right) 109D is provided at such a position that at least a part of the detection target portion (right) 109D overlaps the position of the groove of the photo sensor (right) 110D.

### Photo Sensor

In the exemplary embodiment, a contactless detection mechanism is used, and a photo sensor which is a type of optical sensors is provided. The photo sensor (right) 110D is a photo sensor of a transmission type (photo interrupter), for example. Although not shown in detail, the photo sensor (right) 110D has an emitter and a receiver, and has a groove (recess) therebetween. The width of the groove, i.e., the range between the emitter and the receiver (detection range), is smaller than the width of the right end of the cross-shaped top plate portion 103. In the exemplary embodiment, the photo sensor (right) 110D is provided to the second member 111 via a support pole. The position of the photo sensor (right) 110D is near the center of the right end of the cross-shaped top plate portion 103 and is such a position that the position of the groove overlaps a part of the detection target portion (right) 109D (a part of the detection target portion (right) 109D can move into the groove). Regarding the height of the photo sensor (right) 110D, the photo sensor (right) 110D (the groove thereof) is located at a position slightly lower than the detection target portion (right) 109D in the neutral state.

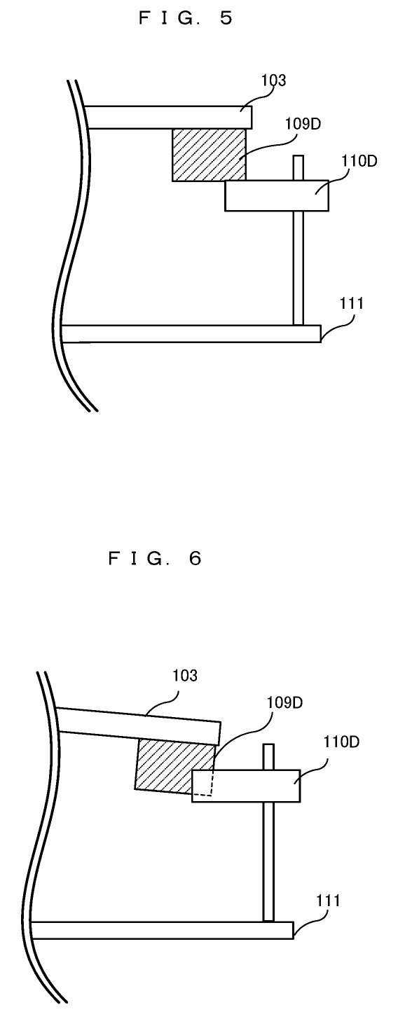

With the above configuration, for example, when the right direction side of the directional pad portion 11 is pressed and operated, the right direction part of the cross-shaped top plate portion 103 is slightly tilted (i.e., a key stroke of the right direction key occurs). For example, from a state as shown in FIG. 5, the detection target portion (right) 109D slightly moves toward the second member 111 side, so that a part of the detection target portion (right) 109D comes to a position in the groove of the photo sensor (right) 110D, as shown in FIG. 6. As a result, it is detected that light from the emitter is blocked. On the basis of the detection result, it can be determined that a right direction input operation on the directional pad portion 11 has been performed.

The widths of the grooves of the photo sensors 110A to 110D of a transmission type are set to be smaller than the widths of the ends in the respective directions of the cross-shaped top plate portion 103, and the detection target portions 109A to 109D having a plate shape as described above are used, whereby the sizes of the photo sensors can be reduced. In addition, owing to the structure using the detection target portions 109A to 109D, the structure for detection can be simplified. Owing to size reduction of the photo sensors, erroneous detection can be prevented. For example, in a case of not using the detection target portions 109A to 109D, it is conceivable that photo sensors having groove widths greater than the widths of the ends of the cross-shaped top plate portion 103 are used. In this case, it is conceivable that the entirety of each end of the cross-shaped top plate portion 103 is a detection target of the photo sensor. As compared to the case of using such photo sensors, the configuration in the exemplary embodiment can prevent erroneous detection.

According to the exemplary embodiment, with the above configuration, it is possible to provide a new structure for a directional pad. In addition, it is possible to provide a favorable operability without losing an operation feeling even in a large-sized controller as shown in FIG. 1 and FIG. 2 which is pressed and operated by a force of an entire arm instead of a fingertip.

### Modifications

In the above exemplary embodiment, the example of using a photo sensor of a transmission type has been shown. However, in another exemplary embodiment, for example, a photo sensor of a reflection type may be used. Without limitation to such a photo sensor, a predetermined optical sensor may be used. For example, an infrared sensor may be used to detect an end of the cross-shaped top plate portion 103 pressed and operated. Without limitation to optical sensors, a predetermined proximity sensor may be used to detect an end of the cross-shaped top plate portion 103 pressed and operated.

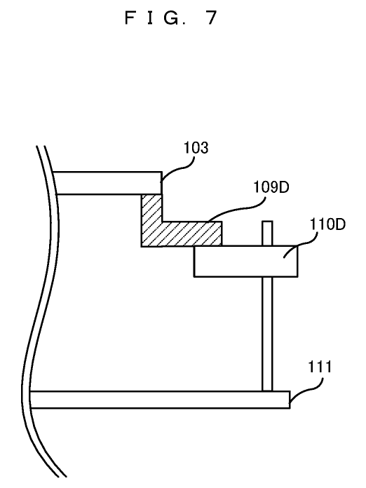

Regarding the detection target portions 109A to 109D, a part thereof may protrude beyond the end of the cross-shaped top plate portion 103, as shown in FIG. 7, for example.

The provided positions of the detection target portions 109A to 109D are not limited to positions around the ends of the cross-shaped top plate portion 103. In another exemplary embodiment, the detection target portions 109A to 109D may be provided at positions toward the center side of the directional pad top 101 relative to the stopper portions 108A to 108D. In this case, for example, the detection target portions 109A to 109D may have shapes extending toward the photo sensors 110A to 110D while detouring around the stopper portions 108A to 108D.

In the above exemplary embodiment, the cushion portions 107A to 107D, the stopper portions 108A to 108D, and the photo sensors 110A to 110D are provided to the same one second member 111. In another exemplary embodiment, these components may be provided to separate second members.

The stopper portions 108A to 108D and the cushion portions 107A to 107D may be configured to allow their heights to be finely adjusted.

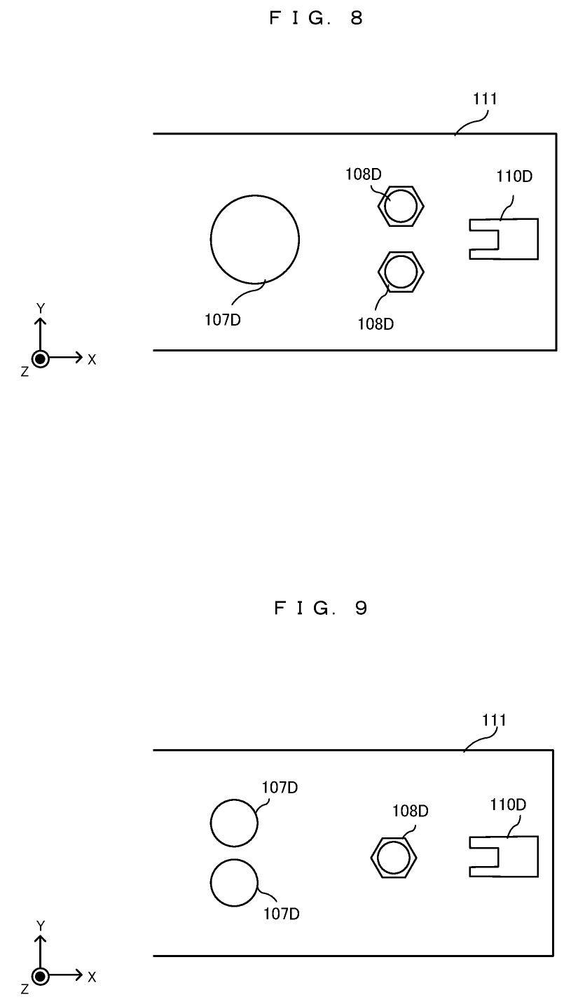

In the above exemplary embodiment, the example in which, in each of the up, down, left, and right directions, the cushion portion, the stopper portion, and the photo sensor are arranged on one line, has been shown (FIG. 3 and FIG. 4). In another exemplary embodiment, these components may not necessarily be arranged on one line as long as they are located at positions along a line connecting the center of the directional pad top 101 (cross-shaped top plate portion 103) and each photo sensor. For example, as shown in FIG. 8, two stopper portions (right) 108D may be provided and located at positions that are not on the above line. Alternatively, for example, as shown in FIG. 9, two cushion portions (right) 107D may be provided and located at positions that are not on the above line. In any case, the arrangement order may be the same as in the above exemplary embodiment.

In another exemplary embodiment, the cushion portions 107A to 107D or the stopper portions 108A to 108D may be omitted. In this regard, in a case of having the cushion portions 107A to 107D, when a pressing operation is performed, the cushion portion 107A to 107D can provide an appropriate reaction force, so that the momentum of the cross-shaped top plate portion 103 being pushed is inhibited to a certain extent. Thus, improvement in an operation feeling can be expected. On the other hand, in a case of not having the cushion portions 107A to 107D, a momentum of a pressing operation is directly transmitted to the cross-shaped top plate portion 103, but an operation response is improved accordingly. Therefore, depending on the content of a game to be played, a configuration not having the cushion portions 107A to 107D may be adopted. Depending on the content of a game, a configuration having the cushion portions 107A to 107D and not having the stopper portions 108A to 108D may be adopted. For example, in a game using the depth of pressing of the directional pad top 101, the stopper portions 108A to 108D may be removed. That is, depending on the content of a game to be played, a configuration in which the cushion portions 107A to 107D or the stopper portions 108A to 108D are removed may be adopted if such a configuration can provide an operation feeling suitable for the game.

The directional pad top 101 and the first member 102 may be formed as one member. The cross-shaped top plate portion 03 may be integrated with the directional pad top 101 and the first member 102 so as to form one member. Alternatively, the cross-shaped top plate portion 03 may be integrated with the first member 102 so as to form one member.

In the above exemplary embodiment, the example in which the detection target portion 109 is provided to the cross-shaped top plate portion 103 has been shown. However, the cross-shaped top plate portion 103 and the detection target portion 109 may be integrally molded together. That is, the cross-shaped top plate portion 103 and the detection target portion 109 may be provided integrally with each other.

In the above exemplary embodiment, the example in which the directional pad portion 11 is configured such that the entirety of the directional pad top 101 is exposed from the housing 10 as shown in FIG. 1 has been shown. In another exemplary embodiment, the game controller 1 may be configured such that only a part of the directional pad top 101, instead of the entirety thereof, is exposed from the housing 10. For example, the game controller 1 may be configured such that only ends in the respective directions of the directional pad top 101 are exposed from the housing 10. Even for the game controller having such a configuration, the above-described configuration is applicable.

While the present disclosure has been described herein, it is to be understood that the above description is, in all aspects, merely an illustrative example, and is not intended to limit the scope thereof. It is to be understood that various modifications and variations can be made without deviating from the scope of the present disclosure.

What is claimed is:

1. A game controller comprising:
a housing;
a directional pad including a pad top configured to receive an input operation and at least partially exposed from an opening provided to the housing, and a cross-shaped plate member provided being covered by the pad top;
an optical sensor provided in the housing and configured to detect movement of the cross-shaped plate member performed by the input operation;
a cushion portion provided in the housing and configured to inhibit movement of the cross-shaped plate member according to the input operation; and
a stopper portion provided in the housing and configured to limit movement of the cross-shaped plate member according to the input operation, wherein
in the housing, the cushion portion and the stopper portion are arranged in an order of the cushion portion and then the stopper portion from a center of the cross-shaped plate member toward the optical sensor.

2. The game controller according to claim 1, wherein
the cross-shaped plate member has a detection target portion at a position that is on a distal end side in a predetermined direction of the cross-shaped plate member and closer to the optical sensor than the stopper portion, and
the optical sensor is located at a position on an outer side relative to the detection target portion, and detects the detection target portion in accordance with the input operation.

3. The game controller according to claim 1, further comprising a base portion to which a shaft portion of the directional pad, the cushion portion, the stopper portion, and the optical sensor are provided.

4. The game controller according to claim 3, wherein
the shaft portion of the directional pad includes
a cross-shaped shaft member provided in the housing, and
a first fixation portion fixing both ends of a shaft corresponding to a first direction of a cross shape of the shaft member, to the base portion, and a second fixation portion fixing both ends of a shaft corresponding to a second direction perpendicular to the first direction, to the cross-shaped plate member.

5. The game controller according to claim 1, wherein
on a direction axis perpendicular to directions of a cross shape of the cross-shaped plate member, a height of the cushion portion is greater than a height of the stopper portion.

6. The game controller according to claim 1, wherein
the optical sensor is a photo sensor, and
a detection range of the photo sensor is smaller than a width of an end in a predetermined direction of the cross-shaped plate member.
